(19) United States
(12) Patent Application Publication
(10) Pub. No.: US 2009/0219792 A1
(43) Pub. Date: Sep. 3, 2009

(54) DATA REPRODUCING DEVICE AND DATA REPRODUCING METHOD

(75) Inventors: Koichi OTAKE, Yokohama-shi (JP); Kyosuke TAKAHASHI, Higashiyamato-shi (JP); Daisuke UCHIDA, Kawasaki-shi (JP); Hiroyuki MORO, Fussa-shi (JP); Yukiyasu TATSUZAWA, Yokohama-shi (JP); Toshihiko KANESHIGE, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/395,360

(22) Filed: Feb. 27, 2009

(30) Foreign Application Priority Data
Feb. 28, 2008 (JP) 2008-048405

(51) Int. Cl. G11B 19/00; G11B 20/10

(52) U.S. Cl. 369/47.5; 369/59.19; G9B/20.009; G9B/19

(57) ABSTRACT

According to one embodiment, a data reproducing device according to the invention includes a frequency difference detector, a phase comparator, a loop filter, an integrator, a first conversion part for converting a value of the integrator into a first conversion value, a second conversion part for converting the value of the integrator into a second conversion value, a first conversion table, a second conversion table, a first D/A converter (DAC), a second D/A converter (DAC), a voltage controlled oscillator (VCO), and a prediction table. The value of the integrator and the first conversion value are associated with each other and stored in the first conversion table in consideration of the characteristics of the VCO. Meanwhile, the value of the integrator and the second conversion value are associated with each other and stored in the second conversion table in consideration of the characteristics of the VCO.

### CROSS-REFERENCE TO RELATED APPLICATIONS

This application is based upon and claims the benefit of priority from Japanese Patent Application No. 2008-048405, filed Feb. 28, 2008, the entire contents of which are incorporated herein by reference.

### BACKGROUND

1. Field

One embodiment of the present invention relates to a data reproducing device, which reproduces data recorded in a recording medium such as an optical disk, and a data reproducing method.

2. Description of the Related Art

In a data reproducing device for reproducing data recorded in an optical disk and other recording media, in general, when a reproduction signal is generated from the recording medium, a clock (reproduction clock) is first generated that reproduces a channel bit clock, which is inherent in a reproduction signal in data recorded in the recording medium, as faithfully as possible. The channel bit clock is a reference recording clock signal used when the data is recorded in the recording medium. The reproduction signal is sampled by using the reproduction clock.

The data recorded in the recording medium may be different in the channel bit clock, depending on the reading position. For example, digital modulation data is recorded in an optical disk so that the linear recording density is constant. Therefore, when the optical disk rotates at a constant speed, the frequency of the channel bit clock inherent in the digital modulation data differs according to the reading position. Thus, the data reproducing device needs to make the reproduction clock constantly follow the channel bit clock so that data can be accurately reproduced even if the channel bit clock is changed.

In the conventional art, there have been proposed various techniques for making the reproduction clock follow the channel bit clock (for example, see, Jpn. Pat. Appln. KOKAI Publication No. 2001-6297). In general, in the data reproducing device, an output frequency of a voltage controlled oscillator (VCO) is used as a frequency of the reproduction clock. In the optical disk reproducing device disclosed in Jpn. Pat. Appln. KOKAI Publication No. 2001-6297, the number of combined resistances for determining the oscillation characteristic of the VCO is changeably constructed from a table. The oscillation characteristic of the VCO is switched based on this table, whereby the frequency bandwidth applicable to the VCO can be widened. Therefore, according to the optical disk reproducing device, the reproduction clock can be made to follow the channel bit clock without depending on the reading position.

When the reading position on the optical disk is jumped from the inner peripheral side to the outer peripheral side or from the outer peripheral side to the inner peripheral side (when the reading position is sought), the channel bit clock is significantly changed within a short time. In this case, the output frequency of the VCO is required to be significantly changed within a short time.

In order to significantly change the output frequency of the VCO within a short time, the control voltage of the VCO is also required to be significantly changed. However, the oscillation characteristic of the VCO is generally designed to be optimum near a predetermined input voltage and a predetermined output frequency. Therefore, when the control voltage of the VCO is significantly changed, the characteristic of the VCO is deviated from the optimum characteristic. As a result, the output frequency is sensitively changed relative to the change in the input voltage, resulting in instability of the output frequency, thereby leading to difficulty in performing stable reproduction. Thus, in the conventional art, if the seek is performed, there is a problem that time is required from after the end of seek for reproduction to stabilize.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic entire configuration diagram showing one embodiment of a data reproducing device and a data reproducing method according to the invention;

FIG. 2 is a view showing an example of a ring oscillator type VCO having a delay line, which can be applied as a VCO having two inputs shown in FIG. 1;

FIG. 3 is an explanatory view showing a state in which a frequency characteristic of an output signal for a first input voltage value is varied by a second input voltage value V2 of the VCO;

FIG. 4 is an explanatory view showing an example of a relation between a value (input value) of an integrator and a first conversion value (output value) stored in a first conversion table and a relation between a value (input value) of the integrator and a second conversion value (output value) stored in a second conversion table;

FIG. 5 is a flow chart showing a procedure when the data reproducing device shown in FIG. 1 makes a reproduction clock follow a channel bit clock;

FIG. 6 is a sub-routine flow chart showing a procedure of a frequency control processing executed in step S2 in FIG. 5; and

FIG. 7 is a sub-routine flow chart showing a procedure of a frequency control processing executed in step S3 in FIG. 5.

### DETAILED DESCRIPTION

Various embodiments according to the invention will be described hereinafter. In general, according to one embodiment of the invention, there is provided a data reproducing device comprising: a voltage controlled oscillator configured to output a signal at a frequency corresponding to a first input voltage and be changed in the output frequency characteristic for the first input voltage in response to a second input voltage; a frequency difference detector configured to detect a frequency difference between data read out from a recording medium and an output signal of the voltage controlled oscillator and output a value corresponding to the frequency difference; an integrator configured to integrate an output value of the frequency difference detector; a first converter configured to output a first conversion value in response to a value of the integrator; a second converter configured to output a second conversion value in response to the value of the integrator; a first DAC configured to convert the first conversion value into a voltage and give the voltage as the first input voltage to the voltage controlled oscillator; and a second DAC configured to convert the second conversion value into a voltage and give the voltage as the second input voltage to the voltage controlled oscillator. When the value of the integrator is changed in a predetermined range, the first converter outputs the first conversion value so that the first input voltage value is within an optimum range inherent in the voltage controlled oscillator.

According to the data reproducing device and the data reproducing method of the invention, it is possible to easily reduce the time from the end of seek until reproduction can be stably performed.

The embodiment of the data reproducing device and the data reproducing method according to the invention are next described in detail with reference to the attached drawings.

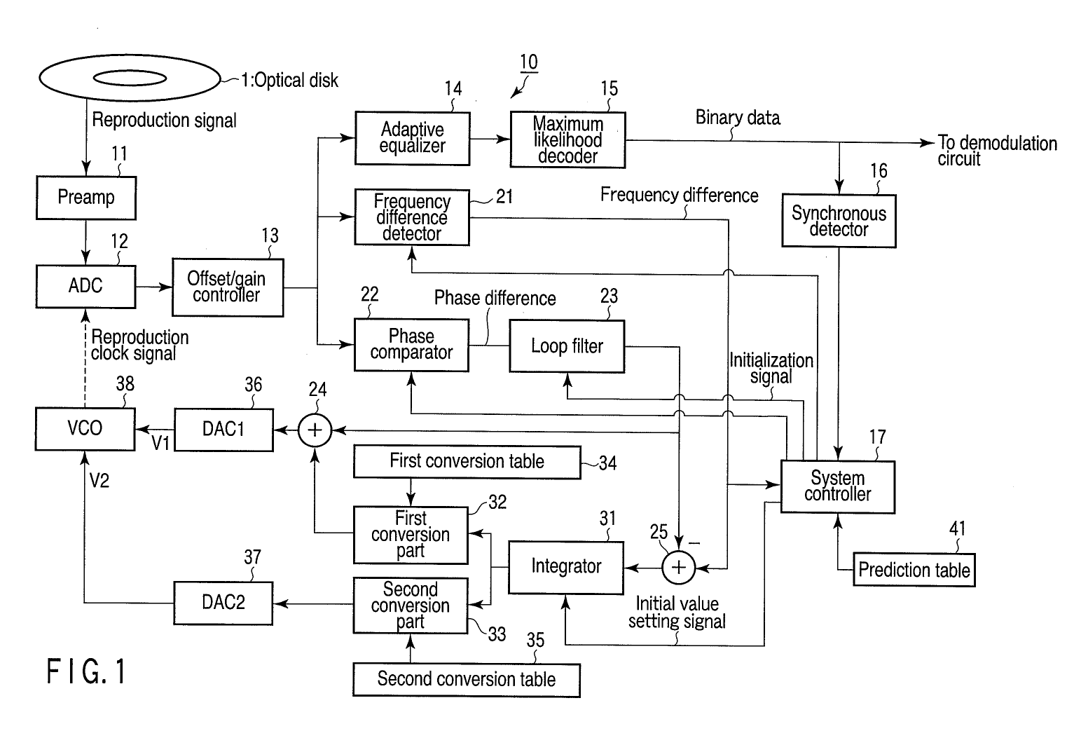

FIG. 1 is a schematic entire configuration diagram showing one embodiment of the data reproducing device and the data reproducing method according to the invention.

In this embodiment, an “optical disk reproducing device,” which is configured so that digital data recorded in an optical disk 1 can be reproduced, is shown as an example of the data reproducing device.

As shown in FIG. 1, a data reproducing device 10 has a preamp 11, A/D converter (ADC) 12, an offset/gain controller 13, an adaptive equalizer 14, a maximum likelihood decoder 15, a synchronous detector 16, a system controller 17 as control means, a frequency difference detector 21, a phase comparator 22, a loop filter 23 as filter means, a first adder 24, a second adder 25, an integrator 31 as integration means, a first conversion part 32, a second conversion part 33, a first conversion table 34, a second conversion table 35, a first D/A converter (DAC) 36, a second D/A converter (DAC) 37, a voltage controlled oscillator (VCO) 38, and a prediction table 41.

The preamp 11 amplifies a reproduction signal obtained from the optical disk 1. The ADC 12 samples the reproduction signal given from the preamp 11 to convert the reproduction signal into a multivalued digital signal by using a reproduction clock generated by the VCO 38. The reproduction clock generated by the VCO 38 is supplied to each circuit block of FIG. 1, as described later.

The offset/gain controller 13 regulates the multivalued reproduction signal so that the average value and the amplitude become desired values, and outputs the regulated signal to the adaptive equalizer 14. The adaptive equalizer 14 applies waveform equalization on the multivalued reproduction signal received from the offset/gain controller 13.

The maximum likelihood decoder 15 outputs the waveform-equalized multivalued reproduction signal as binary data “1” or “0”. The binary data output by the maximum likelihood decoder 15 is subjected to demodulation processing in a demodulation circuit (not shown) on the basis of, for example, ETM (Eight to Twelve Modulation) rule to be error-corrected by an error correction circuit (not shown), and thereafter to be output to a host such as a computer.

The synchronous detector 16 receives the binary data from the maximum likelihood decoder 15 and the reproduction clock from the VCO 38. The synchronous detector 16 detects whether or not the binary data follows a predetermined format to determine whether the phase difference is in a predetermined range and the phase is synchronized, and, thus, to give the determination result to the system controller 17.

The system controller 17 controls an operation of the frequency difference detector 21 and the phase comparator 22 in addition to controlling the operation such as seek. Further, the system controller 17 has a function of rewriting (initializing) a value of the loop filter 23 and the integrator 31 to a predetermined value.

The frequency difference detector 21 detects the frequency difference between data read out from the optical disk 1 and the output signal (reproduction clock signal) of the VCO 38, and outputs a value corresponding to the frequency difference to the system controller 17 and the second adder 25. More specifically, the frequency difference detector 21 obtains the channel bit clock from the multivalued reproduction signal received from the offset/gain controller 13 and detects the frequency difference between the channel bit clock and the reproduction clock.

The phase comparator 22 detects the phase difference between the data read out from the optical disk 1 and the output signal of the VCO 38 and outputs a signal corresponding to the difference. More specifically, the phase comparator 22 obtains the channel bit clock from the multivalued reproduction signal received from the offset/gain controller 13 and detects the phase difference between the channel bit clock and the reproduction clock. Here, the phase difference is detected based on comparison of the data values obtained before and after the 0 cross point of the output signal of the offset/gain controller 13. For example, when an additional value of the data values obtained before and after the 0 cross point is 0, the phase difference is 0.

The loop filter 23 smoothes a signal received from the phase comparator 22 and outputs the smoothed signal as a first output value to the first adder 24. When the phase of the channel bit clock advances more than the phase of the reproduction clock (when the frequency of the channel bit clock is slightly higher than the frequency of the reproduction clock), the phase comparator 22 outputs a negative value.

The first output value corresponds to the phase difference between the channel bit clock and the reproduction clock, and in general, oscillates on a short-term basis. The phase of the reproduction clock is controlled so as to follow the phase of the channel bit clock. Thus, the average value (center value) of the first output value gradually tends to 0 on a long-term basis.

The loop filter 23 outputs the change in the average value of the first output value, which is a second output value, to the second adder 25. The second output value is used as a signal showing a temporal change in the average value of the first output value.

The second output value is added by the integrator 31 through the second adder 25. For example, a value obtained by reducing the first output value can be used as the second output value. In this case, components of the second output value integrated by the integrator 31 are very small on a short-term basis, and, at the same time, the components reflect the tendency of the average value of the first output value on a long-term basis. In this embodiment, a case in which a value obtained by multiplying the first output value by 0.001 is used as the second output value is described.

The first adder 24 adds the first output value received from the loop filter 23 to a first conversion value received from the first conversion part 32 and outputs the value obtained by the addition to the first DAC 36.

The second adder 25 adds a value obtained by inverting the sign of the second output value, received from the loop filter 23, to the output value of the frequency difference detector 21 and outputs the value obtained by the addition to the integrator 31. When the second output value of the loop filter 23 is a value obtained by multiplying the first output value by 0.001 and a sign-inverted value, the second adder 25 adds the second value to the output value of the frequency difference detector 21.

The integrator 31 integrates the value received from the second adder 25 and outputs the value obtained by the integration to the first conversion part 32 and the second conversion part 33.

The first conversion part 32 obtains the first conversion value, related to the value of the integrator 31, from the first conversion table 34 and outputs the first conversion value to the first adder 24. The second conversion part 33 obtains a second conversion value, related to the value of the integrator 31, from the second conversion part 35 and outputs the second conversion value to the second DAC 37.

The first DAC 36 converts the value received from the first adder 24 into a voltage and supplies this voltage as a first input voltage to the VCO 38. The second DAC 37 converts the second conversion value into a voltage and supplies this voltage as a second input voltage to the VCO 38.

Next, the VCO 38 will be described.

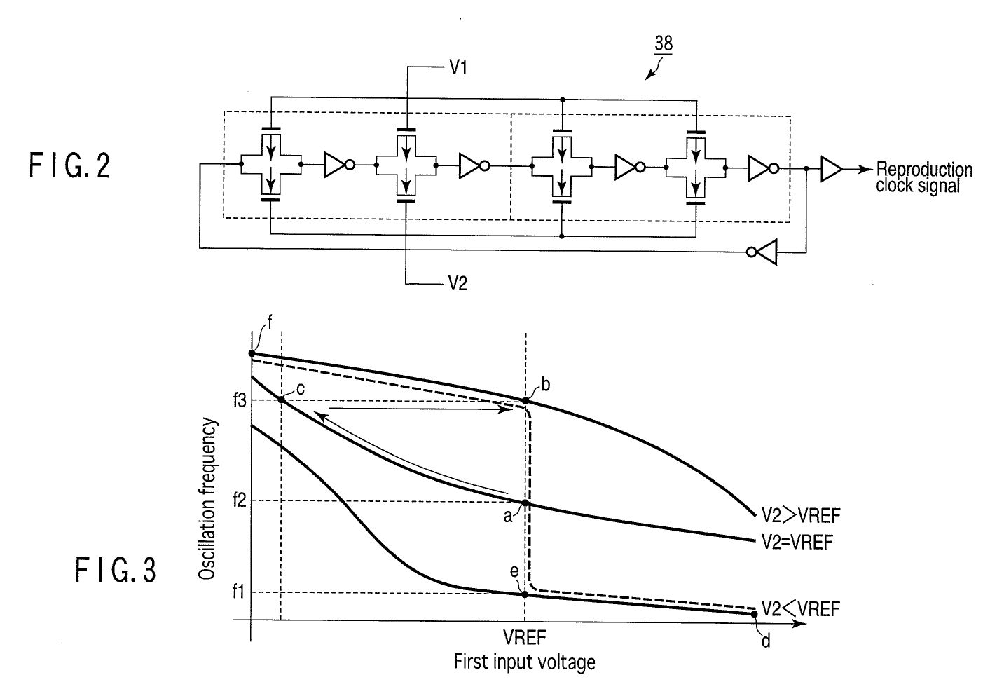

FIG. 2 is a view showing an example of the ring oscillator type VCO 38 having a delay line, which can be applied as the VCO 38 having two inputs shown in FIG. 1.

The VCO 38 is widely used in an LSI of a CMOS. A ring oscillator has a plurality of pairs of P-channel/N-channel MOS transistors with a source and a drain connected, and an inverter is inserted in between each pair. According to the VCO 38 shown in FIG. 2, the gate voltage of the P-channel MOS transistor (P-ch) and the gate voltage of the N-channel MOS transistor (N-ch) are changed, whereby an equivalent ON resistance of the plurality of pairs of transistors (in this example, 4 pairs) can be changed, and the oscillation frequency of the ring oscillator (frequency of the output signal of the VCO 38) can be changed.

When a first input voltage V1 of the VCO 38 is raised, the gate voltage of the P-ch transistor becomes high, and therefore, the equivalent resistance of the P-ch transistor becomes high, and the oscillation frequency becomes low. On the other hand, when the first input voltage V1 is lowered, the equivalent resistance of the P-ch transistor becomes low, and the oscillation frequency becomes high.

Meanwhile, when a second input voltage V2 is raised, the gate voltage of the N-ch transistor becomes high, and therefore, the equivalent resistance of the N-ch transistor becomes low, and the oscillation frequency becomes high. On the other hand, when the second input voltage V2 is lowered, the equivalent resistance of the N-ch transistor becomes high, and the oscillation frequency becomes low. Put simply, when the first input voltage V1 becomes high, the oscillation frequency of the VCO 38 becomes low; meanwhile, when the second input voltage V2 becomes high, the oscillation frequency of the VCO 38 becomes high.

Subsequently, the relation between the output signal of the VCO 38 and the voltages V1 and V2 will be described in more detail.

FIG. 3 is an explanatory view showing a state in which a frequency characteristic of an output signal for a first input voltage value is varied by a second input voltage value V2 of the VCO 38.

The VCO 38 outputs a signal with a frequency corresponding to the voltage V1. The signal output by the VCO 38 is a reproduction clock signal, and the reproduction clock signal is given to all components of the data reproducing device 10 other than an analogue circuit block. In the data reproducing device 10 shown in FIG. 1, the analogue circuit block is the preamp 11 and the VCO 38.

As shown in FIG. 3, the VCO 38 is changed in the frequency characteristic (oscillation frequency characteristic) of the output signal for the voltage V1 in response to the voltage V2.

For example, when the voltage V2 is equal to a reference center voltage VREF, the oscillation frequency characteristic for the voltage V1 is a solid line shown by V2=VREF of FIG. 3. The oscillation frequency of the VCO 38 varies along a solid line shown by V2=VREF in response to the change of the voltage V1. When the voltage V2 is rendered higher than the VREF, the oscillation frequency characteristic for the voltage V1 is a solid line shown by V2>VREF of FIG. 3. When the voltage V2 is rendered lower than the VREF, the oscillation frequency characteristic for the voltage V1 is a solid line shown by V2<VREF of FIG. 3.

As seen in FIG. 3, when the voltage V1 becomes high, the oscillation frequency of the VCO 38 becomes low. When the voltage V2 is raised, the frequency characteristic for the voltage V1 is changed into information. When the voltage V1 is the same (for example, V1=VREF), if the voltage V2 is raised, the oscillation frequency of the VCO 38 becomes high.

Thus, the VCO 38 having two inputs has a wider applicable frequency bandwidth than a voltage controlled oscillator having only one input (or where the voltage V2 of the VCO 38 having two inputs is fixed).

The type of the optical disk 1, data reading position (radial direction position) on the optical disk 1, rotational speed of the optical disk 1, value of the integrator 31 which is predicted as optimum for the reading position and the rotational speed are all associated with each other and stored in the prediction table 41. Alternatively, the type of the optical disk 1 and optimum value of the integrator 31 corresponding to the data reading position on the optical disk 1 and rotational speed of the optical disk 1 can be stored in the prediction table 41. For example when seek is performed, the prediction table 41 is used by the system controller 17 for the purpose of rewriting (initializing) a value of the integrator 31 with a value predicted as optimum on the basis of the reading position and the rotational speed.

In the following description, the ADC 12, the offset/gain controller 13, the phase comparator 22, the loop filter 23, the first DAC 36, and a closed circuit constituted by an input terminal to which the first input voltage of the VCO 38 is input and the output terminal of the VCO 38 are referred to as a phase control loop (phase lock loop).

Next, an example of the operation of the data reproducing device 10 according to this embodiment will be described.

In general, in normal reproduction, when the reproduction clock is phase-locked (locked) to the channel bit clock, several % of the variable width of the oscillation frequency of the VCO 38 is enough for the channel bit clock frequency. However, in order to absorb the variation of the channel bit clock in the seek, a very large width is required so that the variable width of the oscillation frequency of the VCO 38 is about −60% when the seek is performed from the outer periphery to the inner periphery, and about +260% when the seek is performed from the inner periphery to the outer periphery.

As a method for increasing the variable width of the oscillation frequency of the VCO 38, it has been considered to increase a conversion gain of the VCO 38. However, in this case, the conversion gain of the VCO 38 is raised (inclination of a characteristic curve shown in FIG. 3 becomes large), whereby the jitter of the reproduction clock is deteriorated, resulting in deterioration in the error rate of data in the normal reproduction. In this embodiment, the jitter represents the degree of variation of a detected phase difference. The deterioration of the jitter represents an increased variation in the detected phase difference.

In order to simultaneously realize the conditions in normal reproduction and the conditions for optimizing a seek time in high-speed reproduction, it is considered to introduce the VCO 38 having two inputs and a conventional active wide control filter. The first input terminal of the VCO 38 constitutes a part of a phase control loop, and a voltage that gradually changes to follow the change in the channel bit clock is input to the second input terminal. When the active wide control filter is used, it is impossible to follow a rapid change of the channel bit clock, as described later.

In the VCO 38 having two inputs, a desired frequency can be oscillated by controlling the voltages V1 and V2; however, a plurality of operating points oscillating at the same frequency are provided by the combination of the voltage V1 and the voltage V2 (for example, see, operation points b and c of FIG. 3). Meanwhile, a frequency sensitivity characteristic of the VCO 38 differs according to the operating point, and therefore, there is some difference in the reproduction performance according to the operating point, even at the same frequency.

In general, as the voltage V1 separates from the reference center voltage VREF, which is an optimum value inherent in the VCO 38, the characteristics of the VCO 38 often deviates from desired characteristics. Therefore, it is important in terms of the enhancement of the reproduction performance that immediately after the seek, the voltage 1 reaches the operating point in an optimum range (near the VREF), inherent in the VCO 38, in a short time.

For example, in the VCO 38 having the oscillation frequency characteristics shown in FIG. 3, since inclination is small in the operating points a and b, the change in the oscillation frequency for the change in the voltage V1 is small. However, since the inclination is large in the operating point c, the change of the oscillation frequency for the change of the voltage V1 is large. Therefore, the jitter of the reproduction clock is deteriorated. Namely, when the voltage V1 separates from the VREF, it is difficult to perform stable reproduction.

Next, the integrator 31, the first conversion table 34, and the second conversion table 35 will be described.

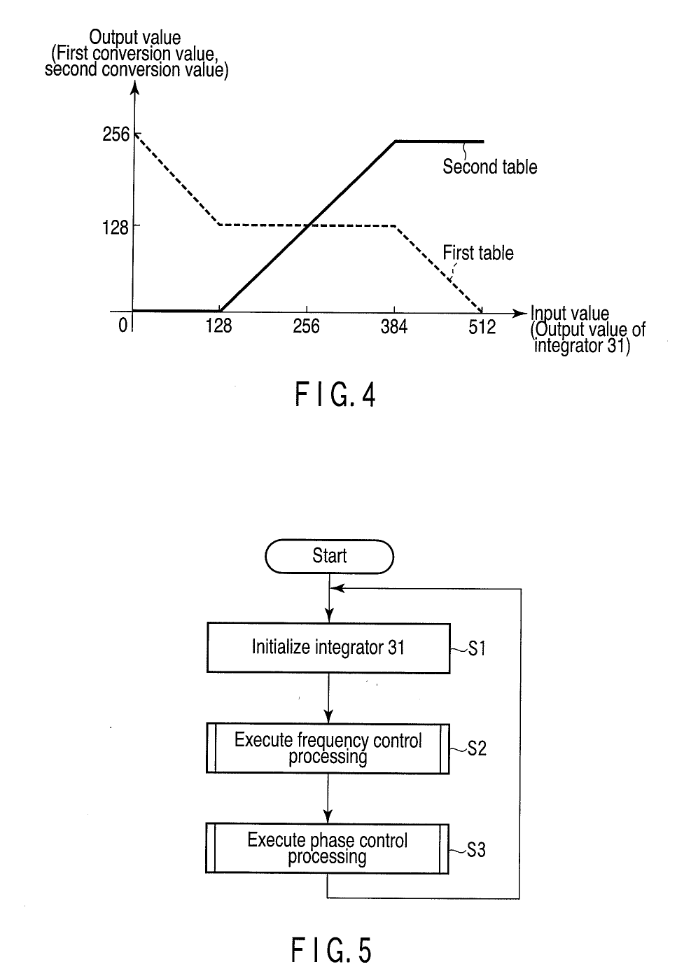

FIG. 4 is a view showing the relation of input and output values in the first conversion table 34 and the relation of input and output values in the second conversion table 35. The horizontal axis is the input value, and the vertical axis is the output value. The horizontal axis corresponds to the output value of the integrator 31.

FIG. 4 shows an example in which the input value is determined from 0 to 512, and the output value is determined from 0 to 256. In each output value of the tables 34 and 35, zero corresponds to a minimum output voltage of the first DAC 36 and the second DAC 37, 128 corresponds to the VREF, and 256 corresponds to a maximum output voltage. As the value of the integrator 31 changes from 0 to 521, the operating point is changed in the order of d, e, a, b, and f, as shown by heavy lines in FIG. 3.

When the output of the loop filter 23 and the value of the integrator 31 are 0, the first conversion part 32 outputs 256 as the first conversion value on the basis of the first conversion table 34, and the second conversion part 33 outputs 0 as the second conversion value on the basis of the second conversion table 35 (operating point d). Therefore, the voltage V1 becomes the maximum output voltage of the first DAC 36, and the voltage V2 becomes the minimum output voltage of the second DAC 37. As a result, the VCO 38 oscillates at the lowest frequency to output the reproduction clock signal.

When the value of the integrator 31 is changed from 0 toward 128, the first conversion value is reduced, and the second conversion value is not changed. Therefore, the voltage V1 is reduced, and the oscillation frequency is raised (operating points d to e).

When the value of the integrator 31 is changed from 128 toward 384, the first conversion value is not changed but remains at 128, and the second conversion value is increased. Therefore, the voltage V2 is increased to thereby change the oscillation frequency characteristic of the VCO 38 (see, FIG. 3), whereby the oscillation frequency is further raised (operating points e to b).

When the value of the integrator 31 is increased toward 512, the first conversion value is reduced, and the second conversion value is not changed. Therefore, the voltage V1 is reduced, and the oscillation frequency is further raised (operating points b to f).

The first conversion table 34 and the second conversion table 35 shown in FIG. 4 are created, whereby when the output value of the integrator 31 is increased, the oscillation frequency of the VCO 38 is monotonously increased.

Further, the first conversion table 34 shown in FIG. 4 is used, whereby when the output value of the integrator 31 is changed in a predetermined range (128 to 384 in FIG. 4), the first input voltage value V1 can be prolonged in the optimum range (near the VREF) inherent in the VCO 38.

FIG. 5 is a flow chart showing a procedure when the data reproducing device 10 shown in FIG. 1 makes the reproduction clock follow the channel bit clock.

This procedure is automatically started at the time when a user instructs the start of reproduction of the optical disk 1 or after the optical disk 1 is loaded in the data reproducing device 10. Meanwhile, this procedure is finished at the time when a user instructs the end of the reproduction or at the time of reaching the final data of the optical disk 1.

First, in step S1, the system controller 17 retrieves the prediction table 41 on the basis of the reading position of data started to be reproduced or data after seek upon reproduction, type of the optical disk 1, and rotational speed of the optical disk 1, and extracts the value of the integrator 31 predicted as optimum. The system controller 17 then initializes the value of the integrator 31 by the extracted value. Thus, the use of the prediction table 41 allows the operating point of the VCO 38 to reach a desired operating point at a higher speed.

The value of the integrator 31 predicted as optimum corresponds to the frequency of the channel bit clock predicted for the type of the optical disk 1, data reading position, and rotational speed. In general, there are individual differences in the characteristics of the VCO 38. Thus, on the basis of the premeasured relation between the value of the integrator 31 and the oscillation frequency of the VCO 38 to be used, the value of the integrator 31 predicted as optimum is determined as the optimum value.

Meanwhile, the predicted frequency of the channel bit clock may be calculated based on a formula, which is provided for each type of optical disk 1 and is a function (formula) of the data reading position and the rotational speed. When such a formula is used, in the contents of the prediction table 41, the value of the integrator 31 predicted as optimum is related to the calculated frequency of the channel bit clock. Also in this case, on the basis of the premeasured relation between the value of the integrator 31 and the oscillation frequency of the VCO 38 to be used, the value of the integrator 31 predicted as optimum is determined.

Further, when the prediction table 41 is not used, the system controller 17 may initialize the value of the integrator 31 by a predetermined value (for example, 256). In this case, the time the operating point of the VCO 38 takes to reach a desired operating point is slightly longer than the case in which the prediction table 41 is used; however, resources are reduced to allow the manufacturing cost to be reduced.

Next, in step S2, the data reproducing device 10 performs frequency control processing, and makes the frequency difference between the channel bit clock and the reproduction clock fall within a predetermined range which is small enough to allow the execution of a phase control processing.

Next, in step S3, a data generating device performs the phase control processing to synchronize the phase of the channel bit clock with the phase of the reproduction clock. When a phase is deviated, the process is returned to step S1.

Subsequently, the frequency control processing (step S2) performed for the purpose of making the frequency difference between the channel bit clock and the reproduction clock fall within a predetermined range which is small enough to allow the execution of the phase control processing will be described in detail.

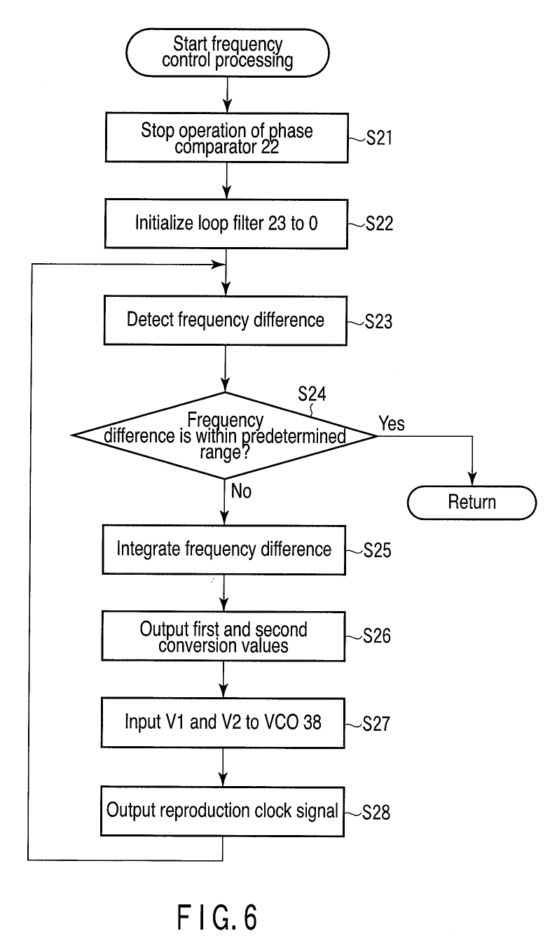

FIG. 6 is a flow chart showing details of the frequency control processing executed in step S2 in FIG. 5.

In the following description, the initial value of the frequency of the reproduction clock is f2 as shown in FIG. 3, the frequency of the channel bit clock is changed from f2 to f3 by seek, and the initial value of the integrator 31 is set to 256 in step S1 in FIG. 5. When the initial value of the reproduction clock is f2, the operating point of the VCO 38 is the point a of FIG. 3. When the operating point of the VCO 38 is moved to the point b of FIG. 3, the frequency of the reproduction clock becomes stable at f3, whereby the data reproducing device 10 can perform stable reproduction.

The above procedure is finished at the time when a user instructs the end of reproduction or at the time of reaching the final data of the optical disk 1.

First, in step S21, the system controller 17 stops the operation of the phase comparator 22.

Next, in step S22, the system controller 17 initializes the value of the loop filter 23 to zero. Since the output of the loop filter 23 is zero, only the value given from the first conversion part 32 is given to the first adder 24, and only the value given from the frequency difference detector 21 is given to the second adder 25.

Next, in step S23, the frequency difference detector 21 detects the frequency difference between the channel bit clock and the reproduction clock and outputs a value corresponding to the frequency difference to the system controller 17 and the second adder 25.

Next, in step S24, the system controller 17 determines whether the value received from the frequency difference detector 21 is within a predetermined range. When the value is within the predetermined range, the system controller 17 determines that the value received from the frequency difference detector 21 is small enough to allow the execution of the phase control processing, and the process proceeds to step S3 in FIG. 5. Meanwhile, when the value is out of the predetermined range, the process proceeds to step S25.

In step S25, the integrator 31 receives the value that corresponds to the frequency difference between the channel bit clock and the reproduction clock from the frequency difference detector 21 through the second adder 25, and integrates (adds) the value with respect to 256 as the initial value.

Next, in step S26, the first conversion part 32 and the second conversion part 33 respectively extract the first conversion value and the second conversion value, related to the value of the integrator 31, from the first conversion table 34 and the second conversion table 35 and output the extracted conversion values respectively to the first adder 24 and the second DAC 37.

For example, when the integration value of the value received by the integrator 31 through the second adder 25 is plus 14, the value of the integrator 31 is 260, and the first conversion value is not changed but remains at 128 (see, FIG. 4). Meanwhile, the second conversion value is 142 and slightly larger than the value before seek (than the value at the time when the frequency of the channel bit clock is f2).

Next, in step S27, the first DAC 36 receives the first conversion value (128) through the first adder 24, and the second DAC 37 receives the second conversion value (142). The first DAC 36 and the second DAC 37 respectively convert the first conversion value and the second conversion value into the voltage V1 (=VREF) and the voltage V2 (>VREF) (see, FIG. 3) and give the voltages V1 and V2 as the first input voltage and the second input voltage to the VCO 38.

Next, in step S28, the VCO 38 outputs the reproduction clock signal on the basis of the first input voltage V1 (=VREF) and the second input voltage V2 (>VREF), and the process is returned to step S23.

The first input voltage V1 is not changed but is always equal to VREF; meanwhile, the second input voltage V2 becomes larger than the VREF. Thus, the operating point of the VCO 38 can be moved from a to b of FIG. 3 without the voltage V1 separating from the reference center voltage VREF which is an optimum value inherent in the VCO 38.

According to the above procedure, the frequency difference between the channel bit clock and the reproduction clock can be made to fall within a predetermined range which is small enough to allow the execution of the phase control processing.

In the conventional technique, which uses an active wide control filter, when the reproduction clock is raised from f2 to f3, the reproduction clock was required to temporarily pass through the operating point c of FIG. 3. However, in the operating point c, since the voltage V1 separates significantly from the VREF, the inclination of the oscillation frequency of the VCO 38 for the voltage V1 becomes large. Therefore, the jitter of the reproduction clock is deteriorated, whereby stable reproduction cannot be performed. Thus, in the conventional art, a period of time to move the operating point of the VCO 38 from c to b of FIG. 3 is required before performing stable reproduction after seek.

According to the data reproducing device 10 of this embodiment, the use of the first conversion table 34 and the second conversion table 35 allows the operating point of the VCO 38 to change while maintaining the voltage V1 in the optimum range inherent in the VCO 38. Therefore, the operating point of the VCO 38 can be moved to an ideal operating point more quickly than the conventional art. Thus, according to the data reproducing device 10 of this embodiment, it is possible to easily reduce the time from the end of seek until reproduction is stably performed. Incidentally, the VCO 38 responses quickly to the change in the input voltage V1, and therefore, in order to perform stable operation, there is the optimum voltage range (near the VREF) of the input voltage V1. However, since the VCO 38 responds more slowly to the change in the input voltage V2 than the input voltage V1, stable operation can be performed in a voltage range larger than the input voltage V1.

Subsequently, a procedure of the phase control processing performed for synchronizing the phase of the channel bit clock and the phase of the reproduction clock will be described.

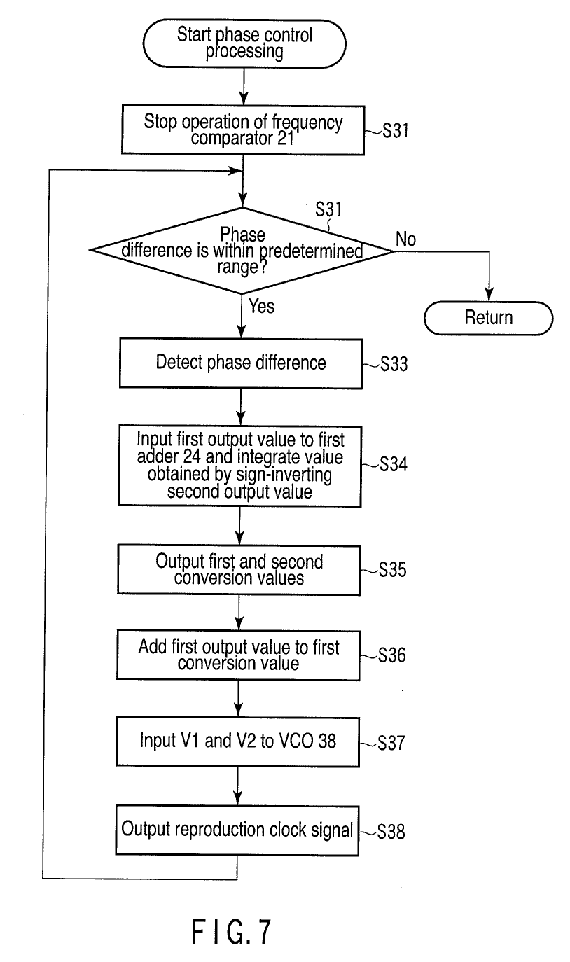

FIG. 7 is a flow chart showing details of the phase control processing executed in step S3 in FIG. 5.

In the following description, the initial value of the frequency of the reproduction clock is f2, the frequency of the channel bit clock is changed from f2 to f4 (not shown), which is slightly higher than f2, and the value of the integrator 31 is 256. The phase control processing is finished at the time a user instructs the end of reproduction or at the time of reaching the final data of the optical disk 1.

First, in step S31, the system controller 17 stops the operation of the frequency difference detector 21. As a result, only the second output value given from the loop filter 23 is given to the second adder 25.

Next, in step S32, the synchronous detector 16 detects whether or not binary data follows a predetermined format and determines whether the phase difference is within a predetermined range. Data recorded in an optical disk includes the same data periodically, for example. When the synchronous detector 16 detects such data, it is determined that the phase difference is within a predetermined range.

In step S32, when the phase difference is out of the predetermined range, the phase control processing is stopped, and, in order to transfer to the frequency control processing, the process proceeds to step S1 in FIG. 5. As such a case, a case where a user indicates that seek should be performed is exemplified. Meanwhile, when the phase difference is within a predetermined range, the process proceeds to step S33 in order to continue the phase control processing. Note that when the following channel bit clock is raised from f2 to f4, it is assumed that the phase difference is maintained within a predetermined range, and the rise in the frequency of the channel clock is absorbed by the following phase control processing.

In step S33, the phase comparator 22 detects the phase difference between the channel bit clock and the reproduction clock and outputs a signal corresponding to the difference.

Next, in step S34, the loop filter 23 smoothes the signal received from the phase comparator 22 to give the smoothed signal, which is the first output value, to the first adder 24. In addition, the loop filter 23 gives a value, which is obtained by multiplying the first output value by 0.001 and is the second output value, to the second adder 25. The second output value, as shown by “−” in FIG. 1, is sign-inverted by the second adder 25 before being output to the integrator 31.

The first output value is a so-called instantaneous value of the phase difference. Hereinafter, a case where the first output value is −3 will be described.

In step S35, the first conversion part 32 and the second conversion part 33 respectively extract the first conversion value and the second conversion value, which are related to the value of the integrator 31, from the first conversion table 34 and the second conversion table 35 to give the extracted conversion values respectively to the first adder 24 and the second DAC 37.

For example, when the first output value is −3, the second output value received by the integrator 31 through the second adder 25 is sign-inverted, resulting in +0.003. As a result, the internal value of the integrator 31 is 256.003. However, the output value of the integrator 31 is effective only in its integer part, and therefore, the second conversion value is not changed in the short term but remains at 128. However, when the internal value of the integrator 31 becomes not less than 257 by the repetition of this process, the second conversion value is increased to 129.

Next, in step S36, the first adder 24 adds the first output value (−3) received from the loop filter 23 to the first conversion value (128) received from the first conversion part 32 to give the additional value (125) to the first DAC 36.

Next, in step S37, the first DAC 36 receives the first conversion value (125) through the first adder 24, and the second DAC 37 receives the second conversion value (128). The first DAC 36 and the second DAC 37 respectively convert the first conversion value and the second conversion value into the voltage V1 and the voltage V2 (see, FIG. 3) and give the voltages V1 and V2 as the first input voltage and the second input voltage to the VCO 38.

Next, in step S38, the VCO 38 outputs the reproduction clock signal on the basis of the first and second input voltages V1 and V2, and the process is returned to step S32.

The first input voltage V1 is influenced by the first output value and the first conversion value. Since the frequency of the channel bit clock is slightly raised, the first output value of the loop filter 23 is a small negative value on average while oscillating up and down by the phase control operation. Further, the initial value of the integration value is 256, and the sign-inverted value of the second output value integrated with the initial value is very small, and therefore, the first conversion value remains at 128. Therefore, the first input voltage V1 oscillates at a value slightly lower than the VREF due to the influence of the oscillation of the first output value.

Meanwhile, the second input voltage V2 is influenced only by the second conversion value. Since the frequency of the channel bit clock is slightly raised, the sign-inverted value of the second output value of the loop filter 23 is a very small positive value (for example, +0.003).

However, since the second output value is integrated by the integrator 31, the influence of the second output value on the value of the integrator 31 becomes gradually larger. Therefore, when the state that the second output value is a negative value continues, the output value of the integrator 31 is increased by 1 after a certain period of time. At this time, the second conversion value is increased by 1, and the second input voltage V2 is slightly increased. As a result, the operating point of the VCO 38 is gradually moved upward in FIG. 3 while the voltage V1 oscillates near VREF.

Thus, according to the procedure shown in FIG. 7, even when the frequency of the channel bit clock is slowly changed, the operating point of the VCO 38 can be moved while maintaining the voltage V1 within the optimum range (near the VREF) inherent in the VCO 38, while the phase difference between the channel bit clock and the reproduction clock is kept locked within a predetermined range.

The frequency of the channel bit clock is slowly changed in, for example, the reading position change in normal reproduction. Therefore, according to the procedure shown in FIG. 7, in the normal reproduction, the voltage V1 can be maintained near the VREF. As shown in FIG. 3, when the voltage V1 is near VREF, the inclination of the oscillation frequency characteristic is small, and therefore, the change in the oscillation frequency for the change in the voltage V1 is also small. Thus, according to the procedure shown in FIG. 7, the normal reproduction can be stably continued while maintaining the jitter of the reproduction clock favorable.

When the frequency of the channel bit clock is significantly changed due to a seek operation, the data reproducing device 10 according to this embodiment can move the operating point of the VCO 38 to a desired operating point at high speed while maintaining the voltage V1 within the optimum range inherent in the VCO 38 by means of the procedure shown in FIG. 2. Therefore, according to the data reproducing device 10 of this embodiment, it is possible to easily reduce the time from the end of seek until reproduction can be stably performed.

Further, when the frequency of the channel bit clock is slowly changed, the data reproducing device 10 according to this embodiment can move the operating point of the VCO 38 while maintaining the voltage V1 within the optimum range (near the VREF) inherent in the VCO 38. Therefore, according to the data reproducing device 10 of this embodiment, it is possible to easily reduce the time from the end of seek until reproduction can be stably performed while maintaining the performance during normal reproduction.

It is to be noted that the invention is not limited to the above embodiment as such, and the components can be modified and embodied without departing from the scope of the invention in an implementation stage. Further, various inventions can be formed by appropriate combinations of a plurality of components disclosed in the above embodiment. For example, several components may be omitted from all the components described in the embodiment.

For example, in this embodiment, the loop filter 23 outputs the second output value; however, this is just one example for reflecting a long-term movement of the average value of the first output value on the integrator 31 in the phase control processing. Therefore, the loop filter 23 outputs only the first output value, and means for performing output corresponding to the long-term motion of the average value of the first output value on the basis of the first output value may be newly provided immediately before the integrator 31.

In addition, the second output value may be a value corresponding to the long-term motion of the average value of the first output value representing the phase difference, and may be the average of the latest 10 first output values in addition to a value obtained by dividing the first output value simply by a positive real number.

Further, the first conversion table 34 and the second conversion table 35 shown in FIG. 4 are just one example. For example, the period in which the voltage V1 is within the optimum range inherent in the VCO 38 may be prolonged, and the first conversion table 34 may be created corresponding to the oscillation frequency characteristic of the VCO 38.

The invention can be applied to an optical disk in which a channel clock is changed in seek. Namely, the invention can be applied to various recording types of optical disks such as CLV, CAV, ZCLV, and ZCAV. In the embodiment of the present invention, the processes of the steps of the flow charts are performed in chronological order in accordance with the described order. However, the invention also includes processes which are not necessarily performed in chronological order but performed in parallel or individually.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data reproducing device comprising:
a voltage controlled oscillator configured to output a clock signal at a frequency corresponding to a first input voltage, the voltage controlled oscillator comprising an output frequency characteristic based on the first input voltage and the output frequency characteristic configured to vary in response to a second input voltage;
a frequency difference detector configured to detect a frequency difference between data read out from a recording medium and an output clock signal of the voltage controlled oscillator and to output a value corresponding to the detected frequency difference;
an integrator configured to integrate an output value of the frequency difference detector;
a first converter configured to output a first conversion value in response to a value of the integrator;
a second converter configured to output a second conversion value in response to a value of the integrator;
a first digital-to-analogue converter (DAC) configured to convert the first conversion value into a voltage and to output the voltage as the first input voltage to the voltage controlled oscillator; and
a second DAC configured to convert the second conversion value into a voltage and to output the voltage as the second input voltage to the voltage controlled oscillator,
wherein the first converter is configured to output the first conversion value in order to control the first input voltage value within a first range inherent in the voltage controlled oscillator when the value of the integrator is changed in a predetermined range.

2. The data reproducing device of claim 1, further comprising:
a first conversion table comprising the value of the integrator and the first conversion value associated with each other and stored corresponding to the characteristics of the voltage controlled oscillator; and
a second conversion table in comprising the value of the integrator and the second conversion value associated with each other and stored corresponding to the characteristics of the voltage controlled oscillator,
wherein the first converter and the second converter are configured to retrieve the first conversion table and the second conversion table based on the value of the integrator and to output the first conversion value and the second conversion value respectively, and
the first conversion value is stored in the first conversion table in response to the value of the integrator in such a manner that the first input voltage value is within the first range inherent in the voltage controlled oscillator when the value of the integrator is changed in the predetermined range.

3. The data reproducing device of claim 2, further comprising:
a phase comparator configured to detect a phase difference between the data read out from the recording medium and the output clock signal of the voltage controlled oscillator and to output a signal corresponding to the difference;
a filter configured to output a first output value and a second output value in response to an output signal of the phase comparator;
a first adder configured to add the first output value of the filter to the first conversion value and to output the value obtained by the addition to the first DAC; and
a second adder configured to add the second output value of the filter to the output value of the frequency difference detector and to output the value obtained by the addition to the integrator,
wherein the integrator is configured to integrate the value received from the second adder, and the second output value of the filter is configured to correspond to a change in an average value of the first output value of the filter.

4. The data reproducing device of claim 3, further comprising a controller configured to control the frequency difference detector and the phase comparator,
wherein the controller is configured to operate the frequency difference detector when the phase difference is out of the predetermined range and to stop the operation of the phase comparator in order to set the output of the filter to zero, and the controller is configured to stop the operation of the frequency difference detector and to operate the phase comparator when the output value of the frequency difference detector is within the predetermined range.

5. The data reproducing device of claim 4, wherein the recording medium is an optical disk and further comprising a prediction table comprising a type of the optical disk, a reading position in a radial direction of data from the optical disk, a rotational speed of the optical disk, and a threshold value of the integrator for the reading position and the rotational speed associated with each other and previously stored, and
the controller is configured to retrieve the prediction table in order to extract the threshold value of the integrator, and, thus, to rewrite the value of the integrator to the threshold value of the integrator when the phase difference between the data read out from the recording medium and the output signal of the voltage controlled oscillator is out of a predetermined range.

6. The data reproducing device of claim 5, wherein the threshold value of the integrator stored in the prediction table is set based on the characteristics of the voltage controlled oscillator.

7. A data reproducing method comprising:
outputting a signal at a frequency corresponding to a first input voltage and a second input voltage by a voltage controlled oscillator comprising an output frequency characteristic based on the first input voltage and the output frequency characteristic configured to changed in response to the second input voltage;
detecting a frequency difference between data read out from a recording medium and an output clock signal of the voltage controlled oscillator;
integrating the detected frequency difference by an integrator;
converting a value of the integrator into a first conversion value;
converting the value of the integrator into a second conversion value;
converting the first conversion value into a voltage to output the voltage as the first input voltage to the voltage controlled oscillator; and
converting the second conversion value into a voltage to output the voltage as the second input voltage to the voltage controlled oscillator,
wherein converting the value of the integrator into the first conversion value comprises outputting the first conversion value in such a manner that the first input voltage value is a voltage value within a first range inherent in the voltage controlled oscillator when the value of the integrator is changed in a predetermined range.

8. The data reproducing method of claim 7, further comprising:
the value of the integrator and the first conversion value being associated with each other corresponding with the characteristics of the voltage controlled oscillator and stored in a first conversion table; and
the value of the integrator and the second conversion value being associated with each other corresponding with the characteristics of the voltage controlled oscillator and stored in a second conversion table,
wherein converting the value of the integrator into the first conversion value comprises retrieving the first conversion table and outputting the first conversion value,
converting the value of the integrator into the second conversion value comprises retrieving the second conversion table and outputting the second conversion value, and
the first conversion value is stored in the first conversion table in response to the value of the integrator in such a manner that the first input voltage value is within the first range inherent in the voltage controlled oscillator when the value of the integrator is changed in a predetermined range.

9. The data reproducing method of claim 8, further comprising:
detecting a phase difference between the data read out from the recording medium and the output clock signal of the voltage controlled oscillator and outputting a signal corresponding to the difference;
outputting a first output value and a second output value in response to a signal corresponding to the phase difference;
adding the first output value to the first conversion value;
converting the value obtained by the addition into a voltage to output the voltage as the first input voltage to the voltage controlled oscillator; and
adding the second output value to a value corresponding to the frequency difference and outputting the value obtained by the addition to the integrator,
wherein the integrator is configured to integrate the additional value, and the second output value corresponds to a change in an average value of the first output value.

10. The data reproducing method of claim 9, wherein the recording medium is an optical disk, the method further comprising:
a type of the optical disk, a reading position in a radial direction of data from the optical disk, a rotational speed of the optical disk, and a threshold value of an integrator for the reading position and the rotational speed being associated with each other and previously stored in a prediction table; and
retrieving the prediction table in order to extract the threshold value of the integrator and rewriting the value of the integrator to the threshold value when the phase difference between the data read out from the recording medium and the output clock signal of the voltage controlled oscillator is out of a predetermined range.

11. The data reproducing method of claim 10, wherein the threshold value of the integrator stored in the prediction table is set based on the characteristics of the voltage controlled oscillator.
